(19) United States
(12) Patent Application Publication
(10) Pub. No.: US 2022/0043203 A1
(43) Pub. Date: Feb. 10, 2022

(54) PHOTONIC CHIP AND METHOD OF MANUFACTURE

(71) Applicant: UNIVERSITY OF SOUTHAMPTON, Hampshire (GB)

(72) Inventors: Graham REED, Hampshire (GB); David THOMSON, Hampshire (GB)

(21) Appl. No.: 17/416,120

(22) PCT Filed: Dec. 19, 2019
(86) PCT No.: PCT/EP2019/086429

§ 371 Date: Jun. 18, 2021

(30) Foreign Application Priority Data
Dec. 21, 2018 (GB) 1820963.5

(51) Int. Cl. G02B 6/122; G02B 6/136; G02B 6/13

(52) U.S. Cl. CPC G02B 6/122; G02B 2006/12097; G02B 6/131; G02B 6/136

(57) ABSTRACT

A silicon photonic chip is provided comprising a top silicon device layer; an insulating layer beneath the top silicon device layer; an intermediate silicon device layer beneath the insulating layer; a further insulating layer beneath the intermediate silicon device layer; a silicon substrate beneath the further insulating layer; and a first silicon waveguide, the first silicon waveguide being partially formed by a portion of the intermediate silicon device layer.

### FIELD OF THE INVENTION

The present invention relates to photonic chips and methods of manufacturing photonic chips and particularly to silicon photonic chips and methods of manufacturing silicon photonic chips in which waveguides of multiple heights can be formed.

### BACKGROUND

In the field of silicon photonics a common platform is a silicon on insulator (SOI) wafer in which a silicon device layer is provided on top of an oxide layer (for example SiO₂) which is in turn is provided on top of a silicon substrate. Passive waveguides and optically active devices can then be formed in the silicon device layer by etching into the device layer or by epitaxially growing silicon from the device layer. The optimal height of a waveguide will depend on its function and so it can be desirable to have waveguides of differing heights present on a single photonic chip.

### SUMMARY OF THE INVENTION

In a first aspect, the invention provides a silicon photonic chip comprising a top silicon device layer; an insulating layer beneath the top silicon device layer; an intermediate silicon device layer beneath the insulating layer; a further insulating layer beneath the intermediate silicon device layer; a silicon substrate beneath the further insulating layer; and a first silicon waveguide, the first silicon waveguide being partially formed by a portion of the intermediate silicon device layer. Alternatively, the silicon photonic chip may comprise: a top silicon device layer; an insulating layer beneath the top silicon device layer; an intermediate silicon device layer beneath the top silicon device layer and beneath and/or laterally offset from the insulating layer; a further insulating layer beneath the insulating layer and the intermediate silicon device layer; a silicon substrate beneath the further insulating layer; and a first silicon waveguide, the first silicon waveguide being partially formed by a portion of the intermediate silicon device layer. All of the optional features and advantages below apply to both alternatives.

This structure means that two silicon layers exist within in the wafer before the processing of any waveguides commences which allows the construction of a photonic chip having waveguides of two distinct heights that are aligned in some way with each other.

For example, the waveguides may be formed with coplanar top surfaces. This allows simpler processing when compared to chips having waveguides of multiple heights formed in the same device layer because the top surfaces of waveguides of two distinct heights will be in the same plane which allows CMP to be used to polish the top surfaces of all waveguides on the device after they have all been formed.

Alternatively, the waveguides may have aligned centre heights. The centre height of the waveguides being the height that is equidistant from the top and bottom surfaces of the waveguide. Multiple waveguides may be formed with aligned optical modes or aligned cores. Where multiple modes are formed in the first waveguide, a height of one or more of these modes may be aligned with a waveguide of a different height on the photonic chip. Aligning waveguides by their centre, optical mode, and/or core in this manner reduces loss when light is passed between the waveguides of differing height.

The first waveguide may extend from the intermediate silicon device layer, past the insulating layer, and to the top silicon device layer. So, a bottom portion of the first silicon waveguide is formed of the intermediate silicon device layer. Note that the insulating layer may only extend in a region beneath the second waveguide. The first waveguide need not be laterally surrounded by the insulating layer.

The insulating layer may have a rounded bottom surface, such that its height is larger in its centre than at its edges. The insulating layer may have a height less than a height of the silicon device layer, such that the intermediate silicon device layer extends directly underneath a part of the insulating layer. The intermediate silicon device layer may extend directly underneath all of the insulating layer, thereby separating the insulating layer from the further insulating layer. Alternatively, the insulating layer may contact the further insulating layer, for example at a central region of the bottom surface of the insulating layer. The whole of the bottom surface of the insulating layer may contact the further insulating layer, such that the intermediate silicon device layer does not extend directly underneath any part of the insulating layer. In this case, all of the intermediate silicon device layer is laterally offset from the insulating layer.

The height of the top silicon device layer may be less than one micron and preferably less than 550 nm and more preferably 220 nm. The height of the intermediate silicon device layer may be between 10 nm and 1500 nm, and preferably between 10 nm and 1000 nm.

The silicon photonic chip may further comprise a second waveguide within the top silicon device layer, the first silicon waveguide having a first height and the second waveguide having a second height, the second height being smaller than the first height.

As the second waveguide is formed within the top device layer, it has a smaller height than the first silicon waveguide. The second waveguide is laterally offset from the first waveguide.

The height of a layer or a waveguide is measured in a direction away from the substrate. A top surface of a layer or a waveguide is the surface that is farthest from the substrate and a bottom surface of a layer or waveguide is the surface that is closest to the substrate. For example, the height of the first silicon waveguide is measured from a bottom surface of the first silicon waveguide to a top surface of the first silicon waveguide in a direction normal to the surface of the substrate.

The second waveguide may be a silicon waveguide and/or a top surface of the first silicon waveguide may be co planar with a top surface of the second waveguide.

The plane of the top surface of the first silicon waveguide may be less than 30 nm above the plane of the top surface of the second waveguide and preferably, the plane of the top surface of the first silicon waveguide is less than 10 nm above the plane of the top surface of the second waveguide. This may be caused by manufacturing processes such as under-polishing or the use of a stop layer, but surfaces that differ in height by less than 50 nm are still regarded as coplanar as the difference in height is negligible.

The first silicon waveguide may extend past a plane of the top surface of the second waveguide so that the top surface of the first silicon waveguide is higher than the plane of the top surface of the second waveguide.

A centre height of the first silicon waveguide may be coplanar with a centre height of the second waveguide, and the centre height of the first silicon waveguide may be equidistant from a top surface of the first silicon waveguide and a bottom surface of the first silicon waveguide and the centre height of the second waveguide may be equidistant from a top surface of the second waveguide and a bottom surface of the second waveguide.

A height of a mode of the first silicon waveguide may be coplanar with a height of a mode of the second waveguide. A height of a core of the first silicon waveguide may be coplanar with a height of a core of the second waveguide. Where multiple modes are formed in the first waveguide, a height of one or more of these modes may be aligned with the second waveguide.

For active photonic components a sub-micron waveguide height may be optimal. For example, when designing an electro-optic modulator it may be desirable to make the mode as compact as possible in order to get maximal overlap with a modulation region which is ideally as small as possible. Also in order to achieve high speed it is desirable to have short, low resistance electrical paths to electrodes. These design features may be achieved in a sub-micron waveguide.

The second height may be less than one micron and preferably may be less than 550 nm. The second height may be between 100 nm and 500 nm. More preferably, the second height may be 220 nm +/−20 nm or 340 nm +/−30 nm.

A top surface of the first silicon waveguide may be co planar with a top surface of the top silicon device layer. The plane of the top surface of the first silicon waveguide may be less than 30 nm above the plane of the top surface of the top silicon device layer and preferably, the plane of the top surface of the first silicon waveguide is less than 10 nm above the plane of the top surface of the top silicon device layer. This may be caused by manufacturing processes such as under-polishing or the use of a stop layer, but surfaces that differ in height by less than 50 nm are still regarded as co planar as the difference in height is negligible.

The first silicon waveguide may extend past a plane of the top surface of the top silicon device layer so that the top surface of the first silicon waveguide is higher than the plane of the top surface of the top silicon device layer.

A height between a bottom surface and a top surface of the top silicon device layer may be less than one micron. This ensures that a waveguide formed in the top silicon device layer is of less than one micron in height. Sub-micron waveguides may be optimal for active photonic components such as an electro-optic modulator.

A height between a top surface of the top silicon device layer and a bottom surface of the intermediate silicon device layer may be greater than one micron. This ensures that a waveguide formed partially of a portion of the intermediate silicon device layer and extending past the insulating layer to the top silicon device layer has a height of greater than one micron. The height between a top surface of the top silicon device layer and a bottom surface of the intermediate silicon device layer may be between 1 micron and 10 microns and preferably this height may be between 2 and 5 microns and more preferably, this height may be 4 microns +/−500 nm or 3 microns.

Silicon optical waveguides of this scale tend to be superior in performance over their sub-micron counterparts in some metrics which render multi-micron waveguides more useful than sub-micron scale waveguides for some applications. Optical losses tend to be lower in larger waveguides since the interaction of sidewall roughness with the core of the optical mode is reduced. The effective index of the waveguide is generally less sensitive to variations in geometrical dimensions meaning that devices produced in such waveguides are more robust against fabrication tolerances. The mode mismatch with the core of typical optical fibres is also reduced meaning that lower coupling losses between the waveguide and a fibre are achievable. Generally it is also simpler to produce devices which are polarisation independent using this scale of waveguide. Multi-micron scale waveguides are generally preferable to form passive optical components.

The first height may be greater than one micron. The first height may be between 1 micron and 10 microns and preferably this height may be between 2 and 5 microns and more preferably, this height may be 4 microns +/−500 nm or 3 microns.

The first silicon waveguide may be formed by epitaxially growing silicon from the intermediate silicon device layer. Epitaxial growth of silicon produces a good quality of waveguide with low optical loss which could be caused by crystal imperfections. Preferably, the epitaxial growth produces single crystal silicon. In some embodiments, the silicon may be deposited as amorphous or polycrystalline silicon instead of epitaxially grown.

The first silicon waveguide may be a rib waveguide and the intermediate silicon device layer may form a slab portion of the rib waveguide and the epitaxially grown silicon may form a strip portion of the rib waveguide. The slab may have a smaller, equal or larger height than the intermediate silicon device layer. Alternatively, the first waveguide may be a strip or a slot waveguide. The second waveguide may be a rib, strip or slot waveguide.

In a second aspect, the invention provides a method of manufacturing a silicon photonic chip, the method comprising: providing a multi-silicon-on-insulator wafer, the wafer comprising a top silicon device layer; an insulating layer beneath the top silicon device layer; an intermediate silicon device layer beneath the insulating layer; a further insulating layer beneath the intermediate silicon device layer; a silicon substrate beneath the further insulating layer; etching through the top silicon device layer and the insulating layer to form a trench and growing silicon from a surface of the intermediate silicon device layer in the trench to form a first silicon waveguide having a first height.

The step of growing silicon may comprise epitaxially growing silicon or may comprise depositing silicon as amorphous or polycrystalline silicon.

The silicon may be grown from the intermediate silicon device layer, past the insulating layer, and past the top silicon device layer to or beyond the plane of the top surface of the top silicon device layer. Because silicon is grown in the trench before waveguides are formed, the high temperatures involved in the growth of silicon cannot damage small waveguides or optical devices as may occur in forming the device of the prior art.

The first height may be greater than one micron. Forming the first silicon waveguide may further comprise planarising a top surface of the epitaxially grown silicon such that the top surface of the first silicon waveguide is co planar with a top surface of the top silicon device layer. Forming the first silicon waveguide may further comprise etching the epitaxially grown silicon. Alternatively, the epitaxially grown silicon may form the waveguide without the need for etching. The method may further comprise etching the top silicon device layer to form a second silicon waveguide, the second silicon waveguide having a second height, the second height being smaller than the first height. The second height may be less than one micron. The method may further comprise etching the top silicon device layer to form a trench, and forming a non-silicon waveguide within the top silicon device layer, wherein the non-silicon waveguide may have a height of less than the first height. The height of the non-silicon waveguide may be less than one micron. A height between a bottom surface and a top surface of the top silicon device layer may be less than one micron. A height between a top surface of the top silicon device layer and a bottom surface of the intermediate silicon device layer may be greater than one micron.

In a third aspect, the invention provides a method of manufacturing a silicon photonic chip, the method comprising: providing a silicon-on-insulator, SOI, wafer, forming an oxide region in a silicon device layer of the wafer, planaraising and/or etching the oxide region such that a top surface of the oxide region is coplanar with a top surface of the silicon device layer, depositing and/or growing silicon over the silicon device layer and the oxide region, to form a multi-SOI wafer, the multi-SOI wafer comprising: a top silicon device layer formed of the deposited and/or grown silicon; an insulating layer beneath the top silicon device layer, the insulating layer being formed of the oxide region; an intermediate silicon device layer beneath the top silicon device layer and beneath and/or laterally offset from the insulating layer, the intermediate silicon device layer being formed of a portion of the silicon device layer of the SOI wafer; a further insulating layer beneath the insulating layer and the intermediate silicon device layer, the further insulating layer being formed of the insulating layer of the silicon-on-insulator wafer; and a silicon substrate beneath the further insulating layer, the silicon substrate being formed of the silicon substrate of the silicon-on-insulator wafer. The method may further comprise etching through the top silicon device layer and into the intermediate silicon device layer at a position that is laterally spaced from the oxide region to form a first silicon waveguide having a first height, and etching the top silicon device layer to form a second silicon waveguide, the second silicon waveguide having a second height, the second height being smaller than the first height.

Using this method to form the multi-SOI wafer allows smaller waveguides to be formed in the top silicon device layer above the oxide region and larger waveguides to be formed in regions that are laterally spaced from the oxide region.

The intermediate silicon device layer is formed by a bottom portion of the silicon device layer of the original SOI wafer and is not limited to a region directly beneath the oxide region. The intermediate silicon device layer extends laterally across the chip and may have a constant height that is the shortest distance between a bottom surface of the oxide region and the top surface of the further insulating layer.

The oxide region may have a rounded bottom surface, such that its height is larger in its centre than at its edges. The oxide region may have a height less than a height of the silicon device layer, such that the intermediate silicon device layer extends directly underneath at least a part of the oxide region. The intermediate silicon device layer may extend directly underneath all of the oxide region, thereby separating the oxide region from the further insulating layer. Alternatively, the oxide region may contact the further insulating layer, for example at a central region of the bottom surface of the oxide region. The whole of a bottom surface of the oxide region may contact the further insulating layer, such that the intermediate silicon device layer does not extend directly underneath the oxide region. In this case, all of the intermediate silicon device layer is laterally offset from the oxide region.

The silicon-on-insulator (SOI) wafer comprises a silicon device layer; an insulating layer beneath the silicon device layer and a silicon substrate beneath the insulating layer. The silicon device layer of the SOI wafer may have a height of 3000 nm. The height of the insulating layer may be 400 nm. The insulating layer may be a buried oxide layer.

The method may further comprise depositing a layer of material that prevents oxidation on the surface of the silicon device layer of the SOI wafer. The material may be silicon nitride, Si₃N₄. A window may be opened in the material. The window may be located in a position in which the second waveguide is to be formed.

The step of forming the oxide region may comprise a thermal oxidation process which grows oxide in the silicon device layer of the SOI wafer. Etching, oxidation an oxidation prevention layer and/or an opening in an oxidation prevention layer may be used to control the top surface of the oxide region. This control may be used such that the top surface of the oxide region can be close to coplanar with the top surface of the silicon device layer of the SOI wafer. The oxide region may be formed of silicon dioxide.

The planarising and/or etching step may remove the material that prevents oxidation from the surface of the silicon device layer of the SOI wafer.

The step of depositing and/or growing silicon may comprise epitaxially growing silicon, and/or depositing amorphous silicon and regrowing the silicon into single crystal silicon using the silicon device layer of the SOI wafer as a seed.

The method may further comprise the features described above in relation to the method of the second aspect. The silicon photonic chip formed by the third aspect may have any of the features described above in relation to the first or second aspects.

Waveguides other than silicon may be used as the first and/or second waveguide having any of the above optional features.

In a fourth aspect, the invention provides a photonic chip comprising a top device layer; an insulating layer beneath the top device layer; an intermediate device layer beneath the insulating layer; a further insulating layer beneath the intermediate device layer; a silicon substrate beneath the further insulating layer; and a first waveguide, the first waveguide being partially formed by a portion of the intermediate device layer.

The photonic chip of this aspect can include any of the optional features of the first aspect and where the device layers are not silicon, the first and/or second waveguide(s) may be formed of silicon or may be formed of another suitable material. Examples of suitable materials are germanium and/or silicon nitride. These materials can be combined with any of the optional features of the first aspect.

Further, the methods of the second and third aspects and their optional features may be modified by replacing silicon in any of the device layers and/or waveguides with another suitable material. For example, germanium or silicon nitride. The features and effects described in relation to the second and third aspect are also applicable to this modified method.

The chip of the first or fourth aspect may be formed using the methods of the second or third aspect and any of the optional features expressed in each aspect are applicable to any of the other aspects. The invention includes the combination of the aspects and preferred features described except where such a combination is clearly impermissible or expressly avoided.

### SUMMARY OF THE FIGURES

Embodiments and experiments illustrating the principles of the invention will now be discussed with reference to the accompanying figures in which:

FIG. 1 shows a cross-sectional view of an example of a photonic chip having two waveguides of two distinct heights that does not form part of the invention.

FIG. 2A shows a cross-sectional view of an example of a double SOI wafer and FIGS. 2B to 2F show steps cross-sectional views of steps in an example of a method of manufacturing the photonic chip of FIG. 2G.

FIG. 3A shows a cross-sectional view of another example of a double SOI wafer and FIGS. 3B to 3D show cross-sectional views of steps in an example of a method of manufacturing the photonic chip of FIG. 3E.

FIGS. 4A to 4D show cross-sectional views of steps in an example of a method of manufacturing the photonic chip of FIG. 4E.

FIGS. 5A to 5E show cross-sectional views of steps in an example of a method of manufacturing another photonic chip.

### DETAILED DESCRIPTION OF THE INVENTION

Aspects and embodiments of the present invention will now be discussed with reference to the accompanying figures. Further aspects and embodiments will be apparent to those skilled in the art. All documents mentioned in this text are incorporated herein by reference.

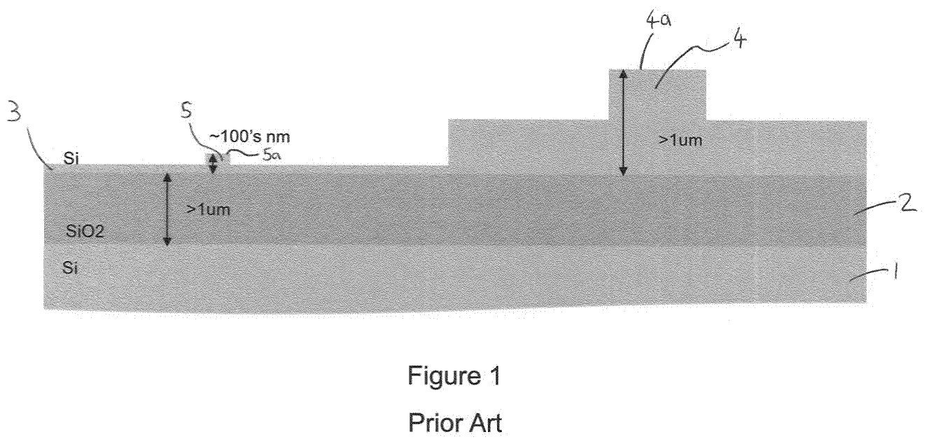

An example of how waveguides of multiple heights could be formed on a single photonic chip is shown in FIG. 1 in which waveguides of differing heights are formed in the device layer of a SOI wafer. FIG. 1 shows a photonic chip with a silicon substrate 1, a SiO₂ insulating layer 2 having a height above the silicon substrate of greater than 1 micron, and a silicon device layer 3. The silicon device layer 3 has a first waveguide 4 with a height above the SiO₂ layer 2 of greater than 1 micron and a second waveguide 5 with a height above the SiO₂ layer 2 in the range of 100 s nm.

The waveguides can be formed by selectively etching the original device layer or by growing silicon from the device layer, depending on the size of the original device layer and the desired size of the waveguide. However, this means that chemical mechanical polishing (CMP) cannot be used on the second waveguide 5 because its top surface 6 is below the top surface 4a of the first waveguide. The first (larger) waveguide 4 cannot be grown after polishing the second (smaller) waveguide 5 because the high temperatures required for epitaxial growth of the first waveguide 4 may damage the second waveguide 5.

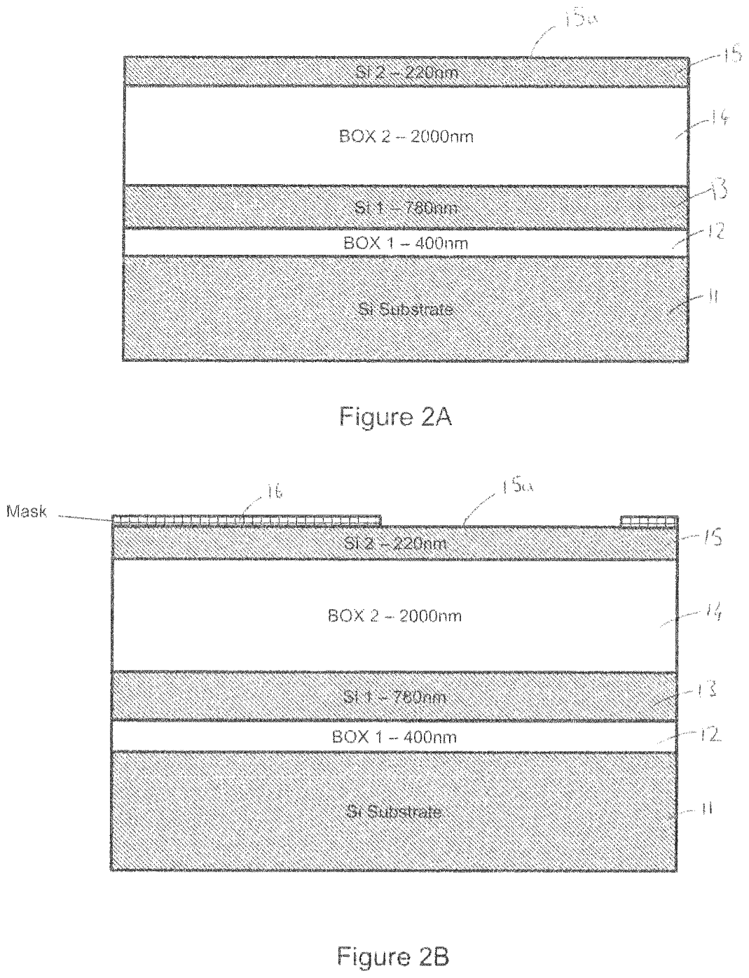

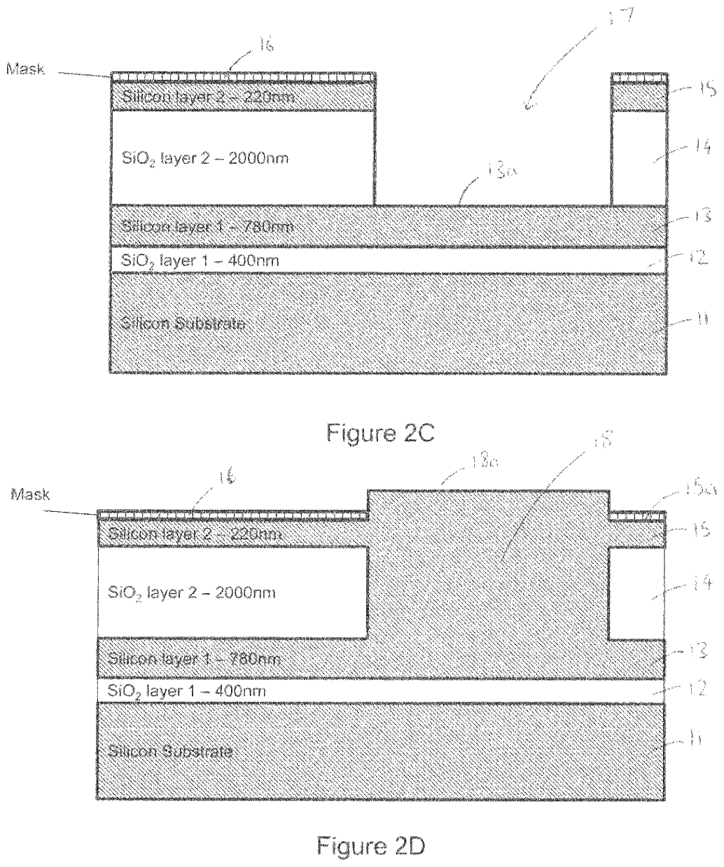

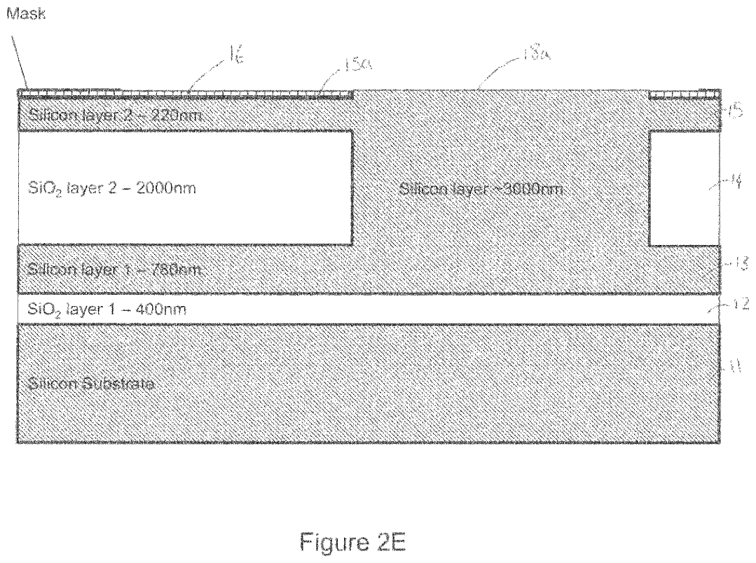

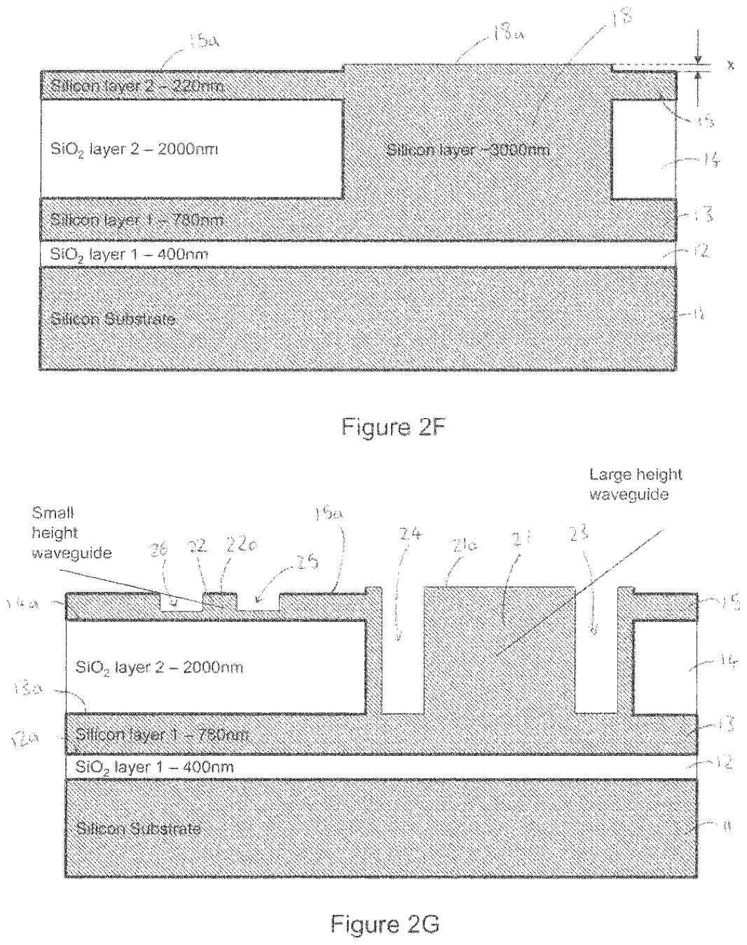

A method of manufacturing a photonic chip according to the present invention will be described with reference to FIGS. 2A to 2G. FIG. 2A shows a double SOI wafer. The wafer has a top silicon device layer 15, an insulating layer 14 beneath the top silicon device layer, an intermediate silicon device layer 13 beneath the insulating layer, a further insulating layer 12 beneath the intermediate silicon device layer, and a silicon substrate 11 beneath the further insulating layer. The double SOI wafer can be formed by wafer bonding.

In FIG. 2B a mask 16 has been deposited to the top surface 15a of the double SOI wafer and patterned using lithography. The mask can be a resist layer or a hard mask material which has been patterned by etching through a resist layer.

Next, as shown in FIG. 2C, a trench 17 is formed in the double SOI wafer by etching the top silicon device layer 15 and the insulating layer 14 to the top surface 13a of the intermediate silicon device layer 13 to expose a seed layer that can be used for single crystal regrowth. In other embodiments, etching may continue into the intermediate silicon device layer 13 so that trench 17 extends into the intermediate silicon device layer 13. Dry etching, wet etching or a combination of both of these techniques may be used. The mask may then be removed or left in place for use in later steps of manufacture.

The seed layer may then be cleaned to prepare the surface for growth. Single crystal silicon is then epitaxially grown from the seed layer at the bottom of trench 17. The grown silicon 18 may overfill the trench as shown in FIG. 2D so that a top surface 18a of the silicon grown in the trench is higher than the top surface 15a of the top silicon device layer 15.

After silicon growth, a planarization process is carried out on the top surface 18a of the silicon 18. Preferably, this process reduces the height of the grown silicon 18 to match the top surface 15a of the top silicon device layer 15. An example of a suitable planarization process is CMP. Preferably, the top surface 18a of the grown silicon and the top surface 15a of the top silicon device layer would match exactly. However, after planarising, the top surface 18a of the grown silicon 18 may be slightly higher than the top surface 15a of the top silicon device layer 15, as shown in FIG. 2E. This is because it is difficult to accurately control the height at which planarization stops.

In this embodiment, a stop layer which polishes slower than silicon is used. This means that polishing can be stopped within the height of the stop layer, ensuring that, after polishing, the top surface 18a of the grown silicon 18 is higher than the top surface 15a of the top silicon device layer by no more than the thickness of the stop layer. In this embodiment, the hard mask 16 has been left in place after its use in the earlier etching step and hard mask 16 can be used as the stop layer during planarising.

The difference in height x between the top surface 15a of the top silicon device layer 15 and the top surface 18a of the grown silicon 18 after planarising, shown in FIG. 2F, is approximately 10 to 30 nm which is small enough that the two surfaces 15a and 18a can be considered coplanar. The height of the grown silicon may vary over its width due to dishing which may occur in planarising causing the centre of the grown silicon to have a lower top surface than the edges of the grown silicon. This introduces a further tolerance of 50 nm, more preferably, 30 nm, more preferably 10 nm. If the top surface 18a of the grown silicon is ‘dished’ in this manner, it is still considered to be coplanar with the top surface 15a of the top silicon device layer 15.

The photonic chip of FIG. 2F can then be processed to produce waveguides of multiple heights, the waveguides having coplanar top surfaces.

As shown in FIG. 2G, rib waveguides may be formed in the grown silicon 18 and the top silicon device layer 15. In some embodiments, grown silicon 18 may form a first waveguide.

Otherwise, the first waveguide 21 can be formed by etching trenches 23 and 24 in the grown silicon from the top surface 18a of the grown silicon to the height of the top surface 13a of the intermediate silicon device layer 13. The silicon between the trenches 23 and 24 forms the ridge of the first waveguide 21 and the intermediate silicon device layer 13 beneath the trenches 23 and 24 forms the slab of the first waveguide 21. The height of the first waveguide 21 is equal to the combined height of the intermediate silicon layer 13 and the planarised grown silicon. This is approximately equal to the combined height of the intermediate silicon layer 13, the insulating layer 14 and the top silicon device layer 15, so that the top surface 21a of the first waveguide is coplanar with the top surface 15a of the top silicon device layer 15. In a modification to this embodiment, the trenches 23 and 24 may be deeper so that the slab has a smaller height than the intermediate silicon device layer 13, or the trenches 23 and 24 may be shallower so that the slab has a larger height than the intermediate silicon device layer 13.

The second waveguide 22 can be formed by etching trenches 25 and 26 in the top silicon device layer 15 from the top surface 15a of the top silicon device layer to a height within the top silicon device layer 15. The silicon between the trenches 25 and 26 forms the ridge of the rib waveguide and the silicon beneath the trenches 25 and 26 forms the slab of the rib waveguide. The height of the second waveguide 22 is equal to the height of the top silicon device layer 15, so the top surface 22a of the second waveguide 22 is coplanar with the top surface 15a of the top silicon device layer 15.

Thus the top surface 21a of the first waveguide 21 is coplanar with the top surface 22a of the second waveguide and the photonic chip of FIG. 2G has two waveguides 21 and 22, each of a different height with coplanar top surfaces 21a and 22a.

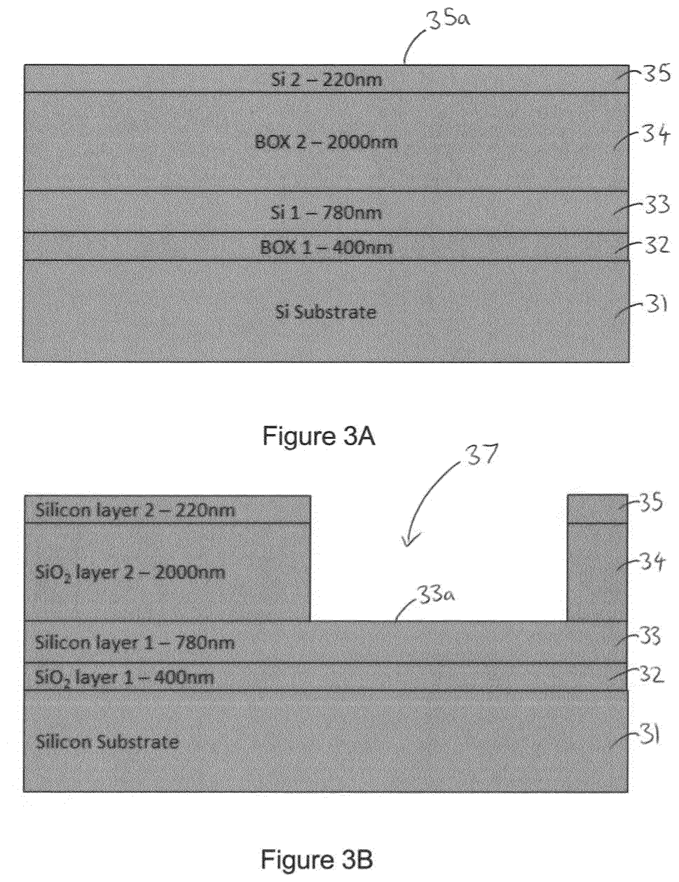

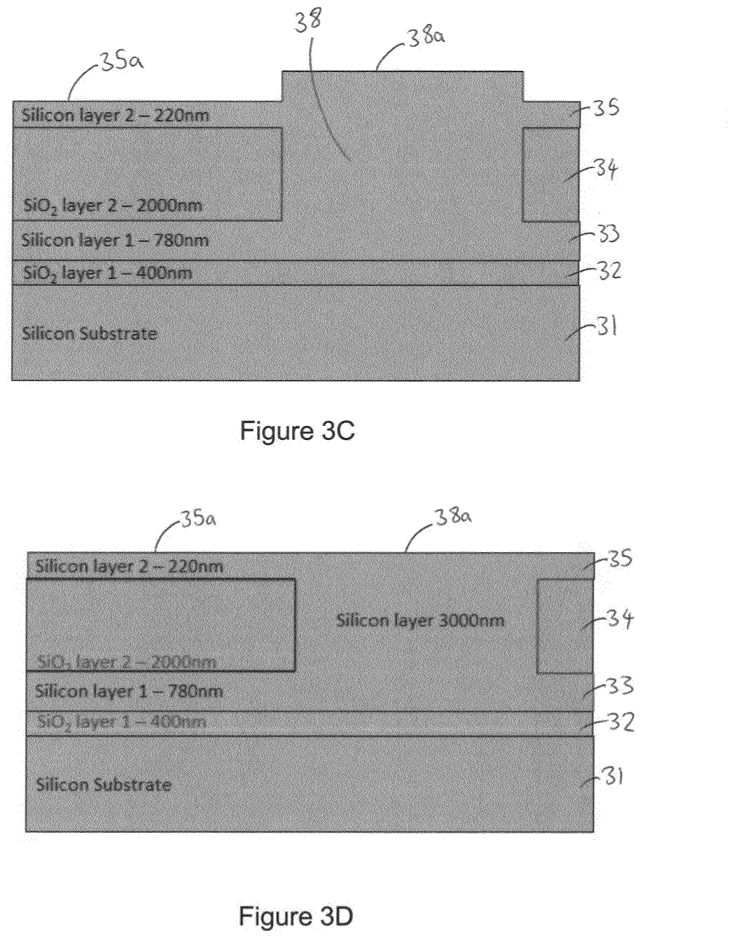

FIGS. 3A to 3E show another process for manufacturing a photonic chip according to the present invention. The method is similar to the method shown in FIGS. 2A to 2G, but does not use the mask as a hard stop and the trenches around the second waveguide extend to meet the trenches of the first waveguide.

FIG. 3A shows a double SOI wafer having a top silicon device layer 35, an insulating layer 34 beneath the top silicon device layer, an intermediate silicon device layer 33 beneath the insulating layer, a further insulating layer 32 beneath the intermediate silicon device layer, and a silicon substrate 31 beneath the further insulating layer.

As shown in FIG. 3B, a trench 37 is then formed in the double SOI wafer by etching the top silicon device layer 35 and the insulating layer 34 to the top surface 33a of the intermediate silicon device layer 33 to expose a seed layer that can be used for single crystal regrowth. In other embodiments, etching may continue into the intermediate silicon device layer 33 so that trench 37 extends into the intermediate silicon device layer 33. Dry etching, wet etching or a combination of both of these techniques may be used. The mask has been removed in FIG. 3B.

The seed layer may then be cleaned to prepare the surface for growth. Single crystal silicon is then epitaxially grown from the seed layer at the bottom of trench 37. The grown silicon 38 may overfill the trench as shown in FIG. 3C so that a top surface 38a of the silicon grown in the trench is higher than the top surface 35a of the top silicon device layer 35.

After silicon growth, a planarization process is carried out on the top surface 38a of the silicon 38. As shown in FIG. 3D, this process reduces the height of the grown silicon 38 to match the top surface 35a of the top silicon device layer 35 to within 10 nm. An example of a suitable planarization process is CMP.

The photonic chip of FIG. 3D can then be processed to produce waveguides of multiple heights, the waveguides having coplanar top surfaces.

As shown in FIG. 3E, rib waveguides may be formed in the grown silicon 38 and the top silicon device layer 35. In some embodiments, grown silicon 38 may form a first waveguide without further etching.

Otherwise, the first waveguide 41 can be formed by etching trenches 43 and 44 in the grown silicon from the top surface 38a of the grown silicon to the height of the top surface 33a of the intermediate silicon device layer 33. The silicon between the trenches 43 and 44 forms the ridge of the first waveguide 41 and the intermediate silicon device layer 33 beneath the trenches 43 and 44 forms the slab of the first waveguide 41. The height of the first waveguide 41 is equal to the combined height of the intermediate silicon layer 33 and the planarised grown silicon. This is equal to the combined height of the intermediate silicon layer 33, the insulating layer 34 and the top silicon device layer 35, so that the top surface 41a of the first waveguide is coplanar with the top surface 35a of the top silicon device layer 35. In a modification to this embodiment, the trenches 43 and 44 may be deeper so that the slab has a smaller height than the intermediate silicon device layer 33, or the trenches 43 and 44 may be shallower so that the slab has a larger height than the intermediate silicon device layer 33.

The second waveguide 42 can be formed by etching trenches 45 and 46 in the top silicon device layer 35 from the top surface 35a of the top silicon device layer to a height within the top silicon device layer 35. The silicon between the trenches 45 and 46 forms the ridge of the rib waveguide and the silicon beneath the trenches 45 and 46 forms the slab of the rib waveguide. The height of the second waveguide 42 is equal to the height of the top silicon device layer 35, so the top surface 42a of the second waveguide 42 is coplanar with the top surface 35a of the top silicon device layer 35. In FIG. 3E, trench 45 extends from the ridge of the second waveguide 42 to trench 44.

Thus the top surface 41a of the first waveguide 41 is coplanar with the top surface 42a of the second waveguide and the photonic chip of FIG. 3E has two waveguides 41 and 42, each of a different height with coplanar top surfaces 41a and 42a.

In the embodiments shown in FIGS. 2A to 2G and FIGS. 3A to 3E trenches 23, 24, 43 and 44 are formed so that their outer sidewalls (the sidewalls distal from the waveguide) are within the grown silicon 18, 38 so that the trenches forming the first waveguide 21, 41 are lined with silicon. In other embodiments the trenches 23, 24, 43 and 44 may be located so that their outer sidewalls are in the same location as trench 17, 37 so that the outer sidewalls of trenches 23, 24, 43 and 44 are formed by insulating layer 14, 34 and the top silicon device layer 15, 35.

In the embodiments shown in FIGS. 2A to 2G and FIGS. 3A to 3E, rib waveguides are formed in the grown silicon 18, 38 and the top silicon device layer 15, 35, but in other embodiments other types of waveguide could be used for the first waveguide, the second waveguide or both waveguides. For example, strip or slot waveguides could be formed.

If the first waveguide is a strip waveguide, then trenches 23, 24, 43 and 44 would be etched to the top surface 12a, 32a of the further insulating layer 12, 32 and the silicon between the trenches forms the strip waveguide. If the first waveguide is a slot waveguide then the trenches 23, 24, 43 and 44 would be etched to the top surface 12a, 32a of the further insulating layer 12, 32 and a slit etched down the middle of the waveguide.

If the second waveguide is a strip waveguide, then trenches 23, 24, 43 and 44 would be etched to the top surface 14a, 34a of the insulating layer 14, 34 and the silicon between the trenches forms the strip waveguide. If the second waveguide is a slot waveguide then the trenches 23, 24, 43 and 44 would be etched to the top surface 14a, 34a of the insulating layer 14, 34 and a slit etched down the middle of the waveguide.

Whichever form of waveguide is produced, a top cladding layer may be applied over the waveguides once formed. The cladding layer may be silicon dioxide.

The insulating layer and the further insulating layer in this embodiment are both formed of silicon dioxide. However, in other embodiments, either or both of these layers may be another oxide or another insulator.

In the embodiments shown in FIGS. 2A to 2G and FIGS. 3A to 3E, the top silicon device layer 15, 35 has a height of 220 nm, the insulating layer 14, 34 has a height of 2000 nm, the intermediate silicon device layer 13, 33 has a height of 780 nm and the further insulating layer 12, 32 has a height of 400 nm. This means that the height of the first waveguide 21, 42 is 3000 nm which is equal to the combined height of the top silicon device layer 15, 35, the insulating layer 14, 34 and the intermediate silicon device layer 13, 33. Thus the height of the first waveguide 21, 41 is greater than 1 micron (preferably 3 microns) and the first waveguide is a multimicron waveguide. The height of the second waveguide 22, 42 is 220 nm which is equal to the height of the top silicon device layer 15, 35. Thus the height of the second waveguide is submicron. In other embodiments, the heights of the layers of the double SOI wafer may be altered so as to allow waveguides of different heights to be formed.

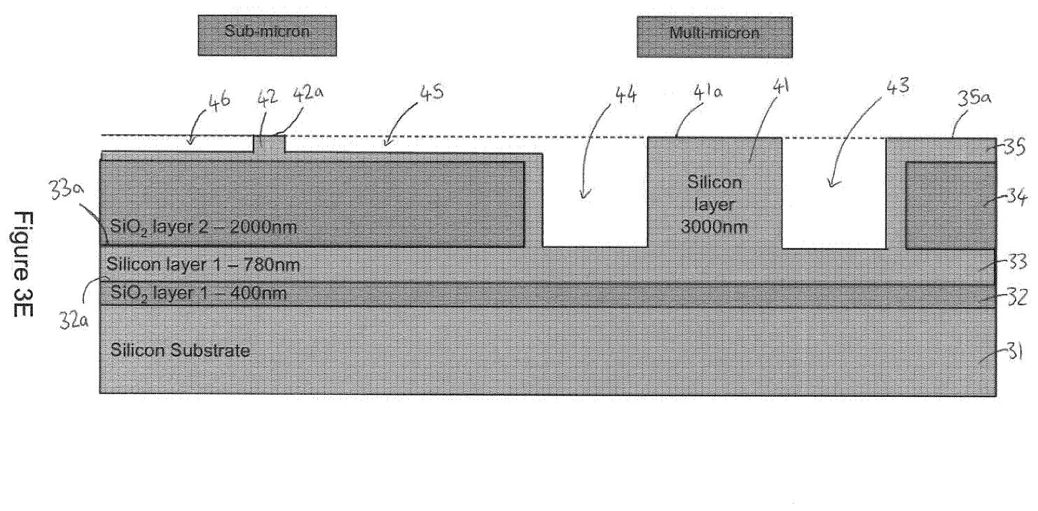

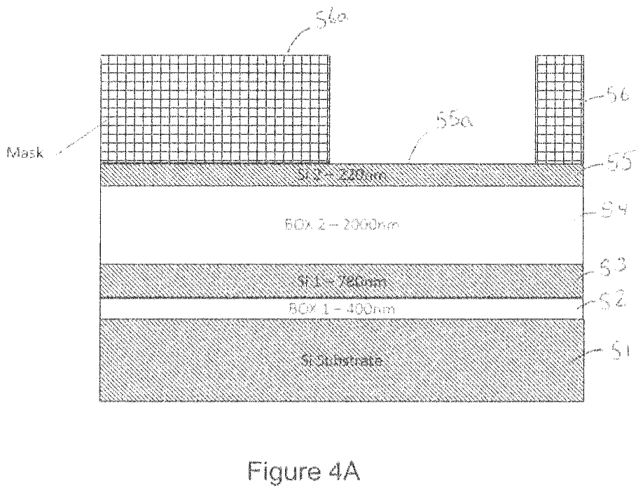

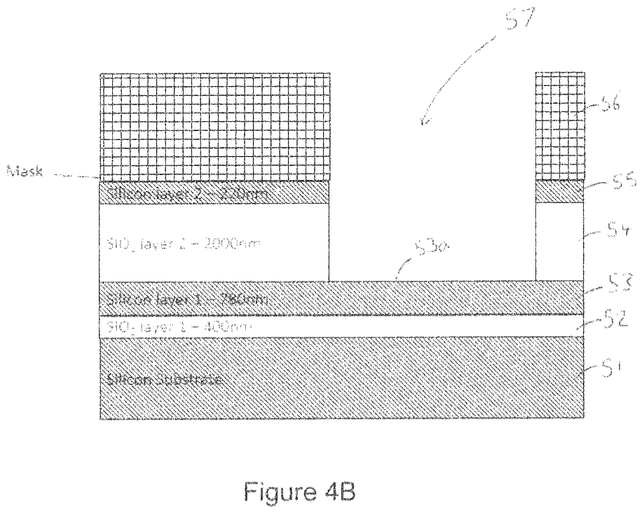

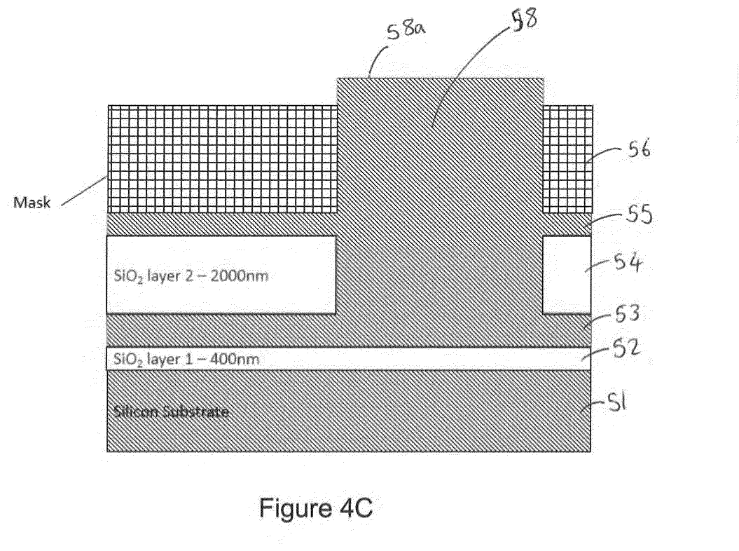

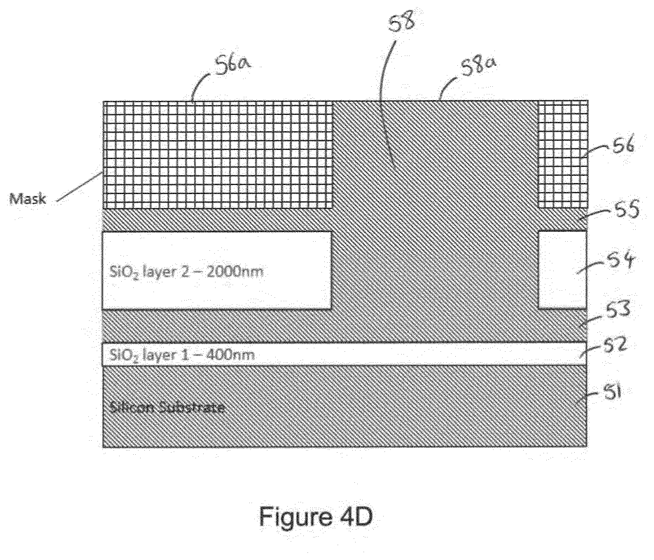

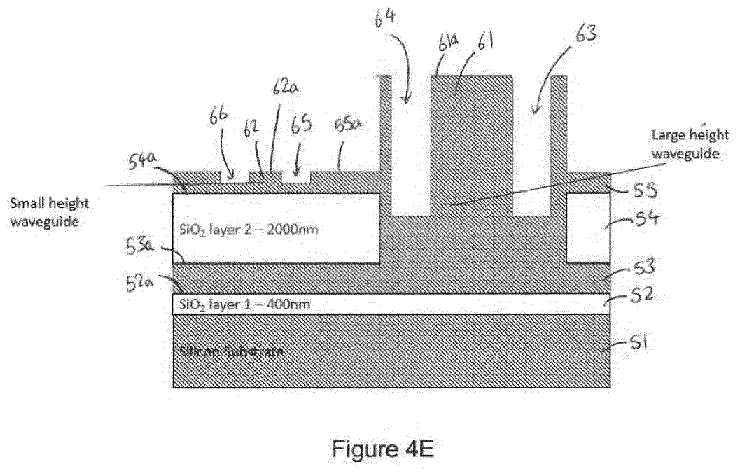

Another method of manufacturing a photonic chip according to the present invention is shown in FIGS. 4A to 4E.

A mask 56 is applied to the top surface 55a of a double SOI wafer and patterned using lithography as shown in FIG. 4A. As can be seen in FIG. 4A, the mask of this embodiment is substantially larger than the mask used in previously described embodiments. The mask may have a height from the top surface 55a of the top silicon device layer 55 to the top surface of the mask 56a of 20 nm to 3000 nm.

A trench is then etched into through the top silicon device layer 55 and through the insulating layer 54 to the top surface 53a of the intermediate silicon device layer 53 to expose a seed layer that can be used for single crystal regrowth. In other embodiments the trench may extend beyond the top surface 53a of the intermediate silicon device layer and into the intermediate silicon device layer 53. Dry etching, wet etching or a combination of both of these techniques may be used. The trench is shown in FIG. 4B. In this embodiment, the mask 56 is left in place for use in later steps of manufacture.

The seed layer may then be cleaned to prepare the surface for growth and single crystal silicon is then epitaxially grown from the seed layer at the bottom of trench 57 in the same way as in the previously described embodiments. The silicon 58 is grown to the top of the trench 57 to at least the height of the top surface 56a of the mask 56. As with previous embodiments, the silicon may overfill the trench as shown in FIG. 4C, so that the top surface 58a of the grown silicon 58 is further from the substrate than the top surface 56a of the mask 56.

Similarly to in the embodiment shown in FIGS. 2A to 2G, the grown silicon is then planarised so that the top surface 58a of the silicon 58 is coplanar with the top surface 56a of the mask 56.

A larger mask is used in this embodiment and the difference in height between the top surface 55a of the top silicon device layer 55 and the top surface 58a of the grown silicon 58 after planarising, shown in FIG. 4D, is equal to the height of the mask. This may be of 20 nm to 3000 nm.

The mask can then be removed and the photonic chip of FIG. 4D can be processed to produce waveguides of multiple heights.

As shown in FIG. 4E, rib waveguides may be formed in the grown silicon 58 and the top silicon device layer 55. In some embodiments, grown silicon 58 may form a first waveguide.

Otherwise, the first waveguide 61 can be formed by etching trenches 63 and 64 in the grown silicon from the top surface 58a of the grown silicon. The silicon between the trenches 63 and 64 forms the ridge of the first waveguide 61 and the silicon beneath the trenches 63 and 64 forms the slab of the first waveguide 61. The height of the first waveguide 61 is equal to the combined height of the intermediate silicon layer 53 and the planarised grown silicon. This is approximately equal to the combined height of the intermediate silicon layer 53, the insulating layer 54, the top silicon device layer 55, and the mask 56 so that the top surface 61a of the first waveguide is farther from the substrate than the top surface 55a of the top silicon device layer 55. In a modification to this embodiment, the trenches 63 and 64 may be deeper so that the slab has a smaller height than the intermediate silicon device layer 53, or trenches 63 and 64 may be shallower so that the slab has a larger height than the intermediate silicon device layer 53.

The second waveguide 62 can be formed by etching trenches 65 and 66 in the top silicon device layer 55 from the top surface 55a of the top silicon device layer to a height within the top silicon device layer 55. The silicon between the trenches 65 and 66 forms the ridge of the rib waveguide and the silicon beneath the trenches 65 and 66 forms the slab of the rib waveguide. The height of the second waveguide 62 is equal to the height of the top silicon device layer 55, so the top surface 62a of the second waveguide 62 is coplanar with the top surface 65a of the top silicon device layer 65.

The centre height of the first waveguide can be aligned with the centre height of the second waveguide which can be beneficial when light is to be guided between the waveguides of different heights. A height of a mode of the first silicon waveguide may be coplanar with a height of a mode of the second waveguide. A height of a core of the first silicon waveguide may be coplanar with a height of a core of the second waveguide. Where multiple modes are formed in the first waveguide, a height of one or more of these modes may be aligned with the second waveguide.

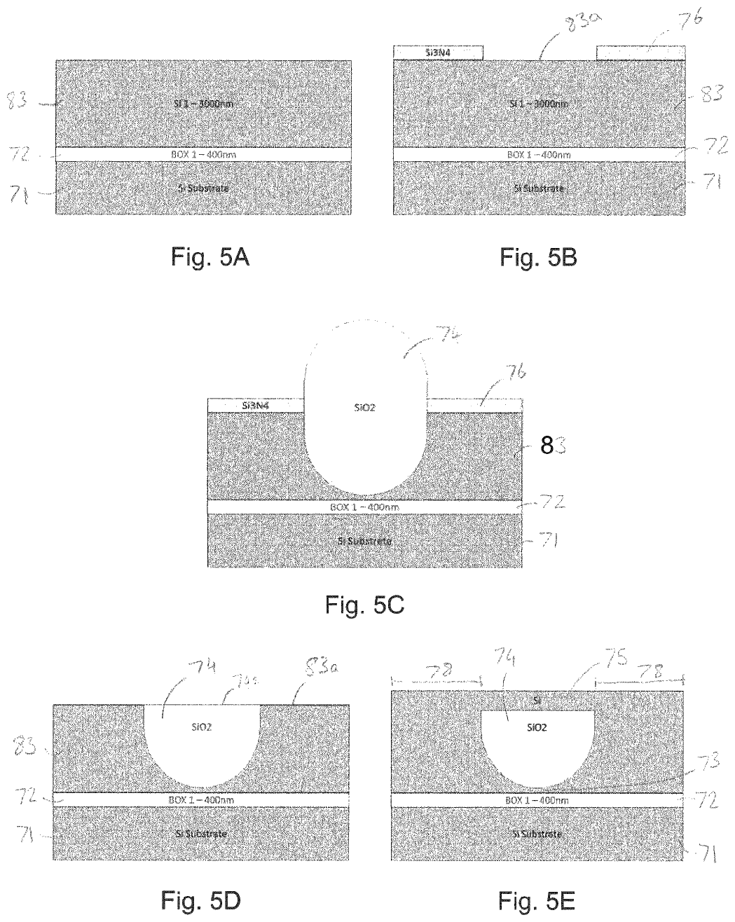

FIGS. 5A to 5E show part of another method of manufacture of a silicon photonic chip. As shown in FIG. 5A, an SOI wafer is provided comprising a silicon device layer 83, an insulating layer 72 beneath the silicon device layer and a silicon substrate 71 beneath the insulating layer. In this example, the silicon device layer has a height of 3000 nm, the insulating layer has a height of 400 nm and the insulating layer is a buried oxide layer, but other heights and materials may be used to suit the application of the chip.

As shown in FIG. 5B, a layer of material 76 (for example silicon nitride) is deposited on a top surface 83a of the silicon device layer 83 to prevent oxidation of the silicon surface 83a. A window has been formed in the material 76, to expose the top surface 83a of the silicon device layer in a region in which the second waveguide will be formed later. The material forms a mask over the top surface 83a of the silicon device layer. In other examples, other ways of controlling the region to be oxidised may be used in place of the mask.

Then, as shown in FIG. 5C, an oxidation process is performed to grow an oxide region 74 in the window formed by the material 76. In this example, a thermal oxidation process is used, but other oxidation processes may alternatively be used. Etching, oxidation an oxidation prevention layer and/or an opening in an oxidation prevention layer may be used to control the growth of the oxide region and/or the top surface of the oxide region. This control may be used such that the top surface of the oxide region can be close to coplanar with the top surface of the silicon device layer of the SOI wafer. The oxide region may be formed of silicon dioxide.

The oxide region is formed in a top portion of the silicon device layer 83 and the oxide region has a height less than the height of the silicon device layer, such that some un-oxidised silicon remains between the oxide region and the insulating layer 72. Alternatively, the oxide region 74 may reach the insulating layer 72. The oxide region 74 may have a rounded bottom surface, such that its height is larger in its centre than at its edges. Thus, if the oxide region 74 contacts the insulating layer 72, the intermediate silicon device layer 73 may not extend directly underneath all of the oxide region, but does extend directly underneath at least a part of the oxide region. Alternatively, the whole of the bottom surface of the oxide region may contact the further insulating layer, such that the intermediate silicon device layer does not extend directly underneath any part of the oxide region. In this case, all of the intermediate silicon device layer is laterally offset from the oxide region.

The intermediate silicon device layer 73 is formed by a bottom portion of the silicon device layer of the original SOI wafer beneath the oxide region 74. The intermediate silicon device layer 73 is not limited to the region directly beneath the oxide region. The intermediate silicon device layer extends laterally across the chip and has a constant height that is the shortest distance between a bottom surface of the oxide region and the top surface of the further insulating layer.

Next, as shown in FIG. 5D, a planarising and/or etching process is performed on the oxide region such that a top surface of the oxide region is coplanar with a top surface of the silicon device layer. In the example shown here, the planarising and/or etching step also removes the material that prevents oxidation from the surface of the silicon device layer of the SOI wafer.

Then, silicon is deposited and/or grown on the oxide region over the silicon device layer and the oxide region, thereby forming a multi-silicon-on-insulator wafer as shown in FIG. 5E. The step of depositing and/or growing silicon may comprise epitaxially growing silicon, and/or depositing amorphous silicon and regrowing the silicon into single crystal silicon using the silicon device layer of the SOI wafer as a seed. The regrowth may be both vertically from the silicon device layer and horizontally from regrown silicon to silicon over the oxide region.

The multi SOI wafer is formed of a top silicon device layer formed of the deposited and/or grown silicon; an insulating layer beneath the top silicon device layer, the insulating layer being formed of the oxide region; an intermediate silicon device layer beneath the insulating layer, the intermediate silicon device layer being formed of a portion of the silicon device layer beneath the oxide region; a further insulating layer beneath the intermediate silicon device layer, the further insulating layer being formed of the insulating layer of the silicon-on-insulator wafer; and a silicon substrate beneath the further insulating layer, the silicon substrate being formed of the silicon substrate of the silicon-on-insulator wafer.

Using this method to form the multi-SOI wafer allows smaller waveguides to be formed in the top silicon device layer above the oxide region and larger waveguides to be formed in regions that are laterally spaced from the oxide region in which only one silicon device layer is present.

Once the oxide region has been formed and the silicon has been deposited and/or grown, the first and second waveguides can be formed in the same manner as in any of the methods described above, except there is no need to etch through an insulating layer when forming the first waveguide. Instead, the first waveguide is formed in a region 78 of the device that is laterally spaced from the oxide region 74. For example, the method may include etching a portion of the silicon device layer that is laterally spaced from the oxide region to form a first silicon waveguide having a first height, and etching the top silicon device layer to form a second silicon waveguide, the second silicon waveguide having a second height, the second height being smaller than the first height.

Active devices such as modulators, Mach-Zender interferometers (MZI), and/or lasers may be formed in the top silicon device layer of any of the photonic chips described herein.

In any of the above described embodiments, any suitable waveguide material may replace silicon in any device layer and/or any waveguide.

The features disclosed in the foregoing description, or in the following claims, or in the accompanying drawings, expressed in their specific forms or in terms of a means for performing the disclosed function, or a method or process for obtaining the disclosed results, as appropriate, may, separately, or in any combination of such features, be utilised for realising the invention in diverse forms thereof.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the spirit and scope of the invention.

For the avoidance of any doubt, any theoretical explanations provided herein are provided for the purposes of improving the understanding of a reader. The inventors do not wish to be bound by any of these theoretical explanations.

Any section headings used herein are for organizational purposes only and are not to be construed as limiting the subject matter described.

Throughout this specification, including the claims which follow, unless the context requires otherwise, the word “comprise” and “include”, and variations such as “comprises”, “comprising”, and “including” will be understood to imply the inclusion of a stated integer or step or group of integers or steps but not the exclusion of any other integer or step or group of integers or steps.

It must be noted that, as used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by the use of the antecedent “about,” it will be understood that the particular value forms another embodiment. The term “about” in relation to a numerical value is optional and means for example +/−10%.

1. A silicon photonic chip comprising:
a top silicon device layer;
an insulating layer beneath the top silicon device layer;
an intermediate silicon device layer beneath the top silicon device layer and beneath and/or laterally offset from the insulating layer;
a further insulating layer beneath the insulating layer and the intermediate silicon device layer;
a silicon substrate beneath the further insulating layer; and
a first silicon waveguide, the first silicon waveguide being partially formed by a portion of the intermediate silicon device layer.

2. A silicon photonic chip according to claim 1, further comprising a second waveguide within the top silicon device layer, the first silicon waveguide having a first height and the second waveguide having a second height, the second height being smaller than the first height.

3. A silicon photonic chip according to claim 2 wherein the second waveguide is a silicon waveguide.

4. A silicon photonic chip according to claim 2, wherein a top surface of the first silicon waveguide is co planar with a top surface of the second waveguide.

5. A silicon photonic chip according to claim 2, wherein a centre height of the first silicon waveguide is coplanar with a centre height of the second waveguide,
wherein the centre height of the first silicon waveguide is equidistant from a top surface of the first silicon waveguide and a bottom surface of the first silicon waveguide and the centre height of the second waveguide is equidistant from a top surface of the second waveguide and a bottom surface of the second waveguide.

6. A silicon photonic chip according to claim 2, wherein the second height is less than one micron.

7. A silicon photonic chip according to claim 1, wherein a top surface of the first silicon waveguide is co planar with a top surface of the top silicon device layer.

8. A silicon photonic chip according to claim 1, wherein a height between a bottom surface and a top surface of the top silicon device layer is less than one micron.

9. A silicon photonic chip according to claim 1, wherein a height between a top surface of the top silicon device layer and a bottom surface of the intermediate silicon device layer is greater than one micron.

10. A silicon photonic chip according to claims 2, wherein the first height is greater than one micron.

11. A silicon photonic chip according to claim 1, wherein the first silicon waveguide is formed by epitaxially growing silicon from the intermediate silicon device layer.

12. A silicon photonic chip according to claim 11 wherein the first silicon waveguide is a rib waveguide and the intermediate silicon device layer forms a slab portion of the rib waveguide and the epitaxially grown silicon forms a strip portion of the rib waveguide.

13. A method of manufacturing a silicon photonic chip, the method comprising:
providing a multi-silicon-on-insulator wafer, the wafer comprising:
a top silicon device layer;
an insulating layer beneath the top silicon device layer;
an intermediate silicon device layer beneath the insulating layer;
a further insulating layer beneath the intermediate silicon device layer;
a silicon substrate beneath the further insulating layer;
etching through the top silicon device layer and the insulating layer to form a trench and
depositing or growing silicon on a surface of the intermediate silicon device layer in the trench to form a first silicon waveguide having a first height.

14. The method of claim 13, wherein the step of depositing or growing silicon comprises epitaxially growing silicon.

15. The method of claim 13, wherein the first height is greater than one micron.

16. The method of claim 13, wherein forming the first silicon waveguide further comprises planarising a top surface of the grown or deposited silicon such that the top surface of the first silicon waveguide is co planar with a top surface of the top silicon device layer.

17. The method of claim 13, wherein forming the first silicon waveguide further comprises etching the grown or deposited silicon.

18. The method of claim 13, further comprising etching the top silicon device layer to form a second silicon waveguide, the second silicon waveguide having a second height, the second height being smaller than the first height.

19. The method of claim 17, wherein the second height is less than one micron.

20. The method of any of claim 15, further comprising
etching the top silicon device layer to form a trench, and
forming a non-silicon waveguide within the top silicon device layer,
wherein the non-silicon waveguide has a height of less than the first height.

21. The method of claim 19, wherein the height of the non-silicon waveguide is less than one micron.

22. The method of claim 13, wherein a height between a bottom surface and a top surface of the top silicon device layer is less than one micron.

23. The method of claim 13, wherein a height between a top surface of the top silicon device layer and a bottom surface of the intermediate silicon device layer is greater than one micron.

24. (canceled)

25. A method of manufacturing a silicon photonic chip, the method comprising:
providing a silicon-on-insulator, SOI, wafer,
forming an oxide region in a silicon device layer of the wafer,
planaraising and/or etching the oxide region such that a top surface of the oxide region is coplanar with a top surface of the silicon device layer,
depositing and/or growing silicon over the silicon device layer and the oxide region, to form a multi-SOI wafer, the multi-SOI wafer comprising:
a top silicon device layer formed of the deposited and/or grown silicon;
an insulating layer beneath the top silicon device layer, the insulating layer being formed of the oxide region;
an intermediate silicon device layer beneath the top silicon device layer and beneath and/or laterally offset from the insulating layer, the intermediate silicon device layer being formed of a portion of the silicon device layer of the SOI wafer;
a further insulating layer beneath the insulating layer and the intermediate silicon device layer, the further insulating layer being formed of the insulating layer of the silicon-on-insulator wafer; and
a silicon substrate beneath the further insulating layer, the silicon substrate being formed of the silicon substrate of the silicon-on-insulator wafer.

26. The method of claim 25, the method further comprising:
etching through the top silicon device layer and into the intermediate silicon device layer at a position that is laterally spaced from the oxide region to form a first silicon waveguide having a first height, and
etching the top silicon device layer to form a second silicon waveguide, the second silicon waveguide having a second height, the second height being smaller than the first height.
